(19) United States
(12) Patent Application Publication
(10) Pub. No.: US 2024/0421523 A1
(43) Pub. Date: Dec. 19, 2024

(54) COMPATIBLE FEMALE SOCKET AND INTELLIGENT CONCEALED BOX

(71) Applicant: NANJING IOT SENSOR TECHNOLOGY CO., LTD (GUANGZHOU), Guangzhou (CN)

(72) Inventors: Xi CAO, Guangzhou (CN); Xinbin SU, Guangzhou (CN); Feng ZHU, Guangzhou (CN); Junling ZHU, Guangzhou (CN); Jianmei YU, Guangzhou (CN); Mingcheng WU, Guangzhou (CN); Zhifu ZHOU, Guangzhou (CN); Quan Liang, Guangzhou (CN)

(21) Appl. No.: 18/822,145

(22) Filed: Aug. 31, 2024

(30) Foreign Application Priority Data
Dec. 21, 2023 (CN) 202311765585.1

(51) Int. Cl. H01R 13/35; H01R 13/50; H01R 24/76; H01R 43/20

(52) U.S. Cl. CPC H01R 13/35; H01R 13/50; H01R 43/20; H01R 24/76

(57) ABSTRACT

The present disclosure discloses a compatible female socket and an intelligent concealed box. The compatible female socket includes a box body, an adjustment unit, and an interface unit; the adjustment unit is rotatably connected to one side, facing an opening of the box body, in the box body; one end of the interface unit facing the opening of the box body is configured to connect various external plugs, and the other end of the interface unit is connected to various wires; the interface unit is slidably connected to the box body; the interface unit is in threaded fit with the adjustment unit; and the adjustment unit is rotated to drive the interface unit to move. The present disclosure has a wide range of application scenes and has the advantages of no wiring and ease of mounting. Therefore, the socket is easy for marketing and has a good market value.

### TECHNICAL FIELD

The present disclosure relates to the technical field of sockets, and in particular to a compatible female socket and an intelligent concealed box.

### BACKGROUND

With the development of the fields such as smart home, smart parks, smart communities, smart offices, smart campuses, smart old-age care, smart medical care, and smart manufacturing, the trend of intelligence of electrical products such as switches and sockets is obvious, and the market share is increasingly high. Compared with a traditional mechanical product, intelligent products have a high damage rate. This brings inconvenience and cost of product maintenance to ordinary users.

At present, most traditional sockets in the market are mainly composed of a junction box and a socket switch during pre-buried pouring. After the pouring is completed, a socket switch is wired and mounted. Traditionally, after the appearance is damaged or during intelligent upgrading renovation, the entire socket needs to be replaced as the socket cannot be disassembled. During the replacement, there is a risk of electric leakage, which wastes the device and also brings lots of environmental management costs.

According to the survey, at present, 37% of switch sockets have been renovated twice to four times (intelligently upgraded and renovated), and 93% of the reasons are that the positions and functions of switch sockets cannot be met. 98% of intelligent device systems have been maintained once or more than once (63% of intelligent systems have been heavily maintained for more than three times).

Moreover, when the socket switch needs to be replaced due to any reason, a large amount of labor cost is required.

At present, various socket switches in the market have obvious shortcomings in various functions, and there is no socket switch in the entire industry that can meet the needs of the vast majority of users. Moreover, with the rapid development of the Internet of Things, various intelligent terminal devices are increasingly used. Therefore, considering the increasing demand for sockets in the market, the present disclosure proposes a compatible female socket and an intelligent concealed box.

### SUMMARY

The present disclosure aims to solve the shortcomings in the prior art and provide a compatible female socket and an intelligent concealed box, which have a wide range of application scenes and have the advantages of no wiring and case of mounting. It is convenient for constructing delivered houses with lower decoration costs. In the future market of the socket industry, the present disclosure more easily meets different home decoration style designs, is convenient for adjusting a style, and can be well received by users. Therefore, the socket is easy for marketing and has a good market value.

In order to achieve the above objective, the present disclosure provides the following technical solutions:

A compatible female socket includes:
a box body;
an adjustment unit, wherein the adjustment unit is rotatably connected to one side, facing an opening of the box body, in the box body; and
an interface unit, wherein one end of the interface unit facing the opening of the box body is configured to connect various external plugs, and the other end of the interface unit is connected to various wires;
the interface unit is slidably connected to the box body; the interface unit is in threaded fit with the adjustment unit; and the adjustment unit is rotated to drive the interface unit to move.

Through the above structure, a high-adaptability socket having a wide range of application scenes is formed, which further has the advantages of no wiring and case of mounting. It is convenient for constructing delivered houses with lower decoration costs. In the future market of the socket industry, the present disclosure more easily meets different home decoration style designs, is convenient for adjusting a style, and can be well received by users. Therefore, the socket is easy for marketing and has a good market value.

Preferably, a thread on the interface unit is arranged at one end, close to the opening of the box body, of an outer surface of the interface unit; and the thread is stopped in front of an edge of an end portion of the interface unit, so that the adjustment unit is unable to be screwed out of the interface unit.

Through the above structure, the rotation of the adjustment unit drives the interface unit to move to an extreme distance between a front end and a rear end, the interface unit will not be separated from the adjustment unit, thus avoiding an operator from performing excessive adjustment to make the interface unit fall off. This design can have a limiting effect on the adjustment performed on the interface unit, thus avoiding excessive pulling and easy damage to a circuit of a wire connected to the interface unit. It not only prevents a maintenance trouble caused by a broken circuit, but also prevents the risk of easy electric shock around the socket due to the broken circuit, thereby improving the safety of the socket during use. Moreover, the trouble and risk of reassembling the interface unit into the socket due to an error in the adjustment operation can be prevented.

Preferably, the adjustment unit is made of a plastic part.

Through the above structure, the adjustment unit has an elasticity. When assembled on a thread with two ends stopped, the adjustment unit can have a slight elastic deformation to ensure that the adjustment unit can be assembled with the interface unit. Meanwhile, this further ensures that the clamping portion is elastic and can be clamped to the mounting opening, so that the entire adjustment unit can be mounted in a protrusion and a limiting bracket after being assembled with the interface unit. Moreover, the adjustment unit made of the plastic part further has the advantages of insulation and low cost, which can improve the safety of the adjustment operation and reduce the cost of the entire socket.

Preferably, scale lines provided in a lengthwise direction of the adjustment unit are further arranged on an inner wall of the box body.

Through the above structure, it is convenient for a user to precisely adjust a front end of the interface unit according to the scale lines, making it easier to adapt to plug specifications of external intelligent terminals.

Preferably, alignment lines are arranged on an inner wall of the box body and the adjustment unit.

Through the above structure, a moving distance of the interface unit is measured according to each rotation of the adjustment unit. This design allows a user to clearly learn what angle the user should rotate the adjustment unit to make the interface unit move to an appropriate position.

Preferably, an antiskid structure is arranged on an outer surface of the adjustment unit.

By using the above structure, a user can avoid slippage during adjustment, and the operation experience of the user is better.

Preferably, the antiskid structure includes four ringlike recesses which are uniformly distributed.

Through the above structure, firstly, it is convenient for a user to have better grip points during adjustment; and secondly, every quarter of the rotation makes the moving distance of the interface unit fixed. This also allows the user to precisely adjust the position of the interface unit.

Preferably, a mounting opening is provided in a bottom of the box body; and the adjustment unit is rotatably connected to the mounting opening.

Through the above structure, a mounting position is provided for the adjustment unit.

Preferably, the box body is further provided with a limiting structure at a position close to the mounting opening; the limiting structure is arranged in a manner of being parallel to a moving direction of the interface unit; a sliding chute is provided on an outer surface of the interface unit; and the limiting structure is slidably connected into the sliding chute.

Through the above structure, a path is provided for the movement of the interface unit on the box body.

Preferably, at least one end of the sliding chute does not penetrate through a thread on a surface of the entire interface unit.

Through the above structure, a shell can be avoided from completely sliding out and being separated from the adjustment unit, thus avoiding excessive pulling and easy damage to a circuit of a wire connected to the interface unit. It not only prevents a maintenance trouble caused by a broken circuit, but also prevents the risk of easy electric shock around the socket due to the broken circuit, thereby improving the safety of the socket during use. Moreover, the trouble and risk of reassembling the interface unit into the socket due to an error in the adjustment operation can be prevented.

Preferably, the adjustment unit is rotatably connected to an inner side of a rim of the mounting opening.

Through the above structure, the entire interface unit is integrated into a very narrow space, which can rival a traditional small-sized and lightweight socket. Compared with a traditional socket, the compatible female socket can achieve a small volume similar to that of a traditional socket switch to adapt to mounting in various mounting requirements, such as a corner, a bottom surface, and a tabletop, and has a function of adjustable mounting of an intelligent terminal device that the traditional socket does not have. Therefore, the compatible female socket has a very wide range of application scenes.

Preferably, a radial section of the mounting opening is U-shaped; and the adjustment unit is rotatably connected to an outer side of a rim of the mounting opening.

Through the above structure, there is a larger space in the interface unit for the mounting of the adjustment unit. When the interface unit needs to be connected to a plug with more wiring terminals, a shell with more first through holes needs to be used. At this time, a diameter of the shell may be larger, so that the shell can adapt to the mounting of the adjustment unit that requires a larger mounting space.

Preferably, the adjustment unit is rotatably connected to the mounting opening through a bearing.

Through the above structure, the rotation of the adjustment unit can reduce the friction between the adjustment unit and the mounting opening, making the adjustment more sensitive.

Preferably, a clamping portion is arranged on an end surface of one end, opposite to the opening of the box body, of the adjustment unit; the clamping portion is matched with a rim of the mounting opening; and a radial section of the clamping portion is L-shaped.

Through the above structure, the adjustment unit can be ensured to be easily mounted into the mounting opening, and it is difficult for the adjustment unit to be separated from the mounting opening after the adjustment unit is mounted in the mounting opening. This makes the adjustment unit and the box body mounted at high firmness, preventing damage to the entire socket caused by the separation of the adjustment unit from the mounting opening due to an excessive plugging force on an external plug, and ensuring that this socket product has sufficient quality assurance.

Preferably, a bottom of the box body has a protrusion towards the opening of the box body; and the mounting opening is arranged at the protrusion.

Preferably, several wiring terminals are arranged on one side of the protrusion away from an orientation of the opening of the box body; a limiting bracket is fixedly mounted on the wiring terminals; and a limiting structure is arranged on a center hole wall of the limiting bracket.

Through the above structure, this socket has the characteristic that the limiting bracket mounted through a screw is detachable and has better firmness, and a subsequent mounting position is provided for a printed circuit board (PCB), so that the PCB is mounted on the limiting bracket and the box body more tightly and firmly, and the occupied space is small.

Preferably, the protrusion is tubular; the limiting structure is arranged on the center hole wall of the limiting bracket; the mounting opening is arranged on an end surface of the protrusion facing the opening of the box body; and a diameter of the mounting opening is less than an inner diameter of the protrusion.

Preferably, the protrusion is horn-like; a surface of one side, away from the adjustment unit, of the protrusion is fixedly connected with a limiting bracket; and the limiting structure is arranged on a center hole wall of the limiting bracket.

Through the above structure, a mounting position and a moving path are provided for the interface unit; the entire interface unit is integrated into a very narrow space, which can rival a traditional small-sized and lightweight socket. Compared with a traditional socket, the compatible female socket can achieve a small volume similar to that of a traditional socket switch to adapt to mounting in various mounting requirements, such as a corner, a bottom surface, and a tabletop, and has a function of adjustable mounting of an intelligent terminal device that the traditional socket does not have. Therefore, the compatible female socket has a very wide range of application scenes.

Preferably, the limiting bracket and the protrusion are adhered and fixed with each other.

Preferably, several screw holes are provided on a surface of the protrusion; and screws are screwed into the screw holes to fix the limiting bracket.

Through the above structure, when an internal circuit of this socket generates a large amount of heat or the heat of an external intelligent terminal diffuses into the box body, it is hard for the limiting bracket to be loosened and even separated due to the fact that glue is heated to be melted.

Preferably, several buckle slots are provided on a surface of the protrusion opposite to the opening of the box body; and buckles matched with the buckle slots are arranged on a surface of one side, close to the protrusion, of the limiting bracket.

Through the above structure, the limiting bracket is detachably mounted and connected to the protrusion by plugging the buckles into the buckle slots. This mode has the advantages that the mounting of the limiting bracket can be quickly completed. It is faster than a thread mode, and the glue will not be melted due to the high heat of the socket.

Preferably, the interface unit includes:
a shell, wherein a thread is provided on a surface of the shell; the shell is slidably connected into the adjustment unit; a first through hole is provided inside the shell; and
a decorative cover, wherein the decorative cover is plugged onto an end surface of the shell facing the opening of the box body; a second through hole is provided on the decorative cover; the second through hole is aligned with the first through hole; and
a conductive clamp is fixedly connected into the first through hole.

Preferably, a limiting slot which is arranged in the moving direction of the interface unit is provided in the shell; and the decorative cover is provided with a plugging strip matched with the limiting slot.

Through the above structure, on the end surface of the shell, the plugging strip can be plugged into the limiting slot to mount the decorative cover. Therefore, this structural design makes the assembling operation very simple and convenient, and can save labor.

Preferably, the limiting slot is provided on an inner wall of the shell.

Through the above structure, the appearance of the shell is more concise and beautiful.

Preferably, the compatible female socket further includes a safety door; the safety door is rotatably connected into the decorative cover and is located between the decorative cover and the shell; several penetration openings aligned with the first through hole are provided on the safety door; and an avoidance hole for allowing the plugging strip to pass through is further provided on the safety door.

Through the above structure, the second through hole and the first through hole can be both blocked and connected. Therefore, after the overall mounting of the socket is completed and before an external plug is plugged, an external non-plug item or a living object cannot enter the decorative cover and the shell. This can avoid a safety accident of electric shock caused by human touch, and especially prevent naughty children from sticking their fingers into the socket. This can further reduce the entry of dust, impurities, and other foreign objects that may affect the power supply efficiency of the socket and lower the difficulty of wiping and maintenance, thereby improving the usability and safety of the socket and reducing the maintenance cost of the socket.

Preferably, a baffle plate is arranged at one end of the decorative cover close to the safety door and one side of the decorative cover located in the second through hole; when the safety door is mounted at the decorative cover, the baffle plate is located in the penetration openings; an avoidance slot that is able to accommodate the baffle plate is provided on one side wall surface of the safety door located at the penetration openings; and the avoidance slot is inclined or arc-shaped.

Through the above structure, when an external plug is plugged, the plug moves directly along a surface of the avoidance slot to drive the safety door to rotate, so that the first through hole and the second through hole are connected to enable the external plug to be plugged.

Preferably, a reset spring is further arranged at the safety door; one end of the reset spring is connected to the safety door; the other end of the reset spring is connected to the shell or the decorative cover; and
when no external plug is plugged into the interface unit through the elasticity of the reset spring, the safety door is kept in a state of blocking the first through hole and the second through hole.

Through the above structure, the first through hole and the second through hole are automatically blocked by the safety door after a plug is pulled out and when there is no external plug being plugged into the socket.

Preferably, an arc-shaped accommodating slot is provided on an end surface of the safety door close to the shell; the reset spring is mounted in the accommodating slot; and a convex block capable of extending into the accommodating slot is arranged on an end surface of the shell close to the safety door.

Through the above structure, to this end, this structural design not only provides a sufficient mounting position for the reset spring in a very narrow space, ensuring that this technical solution is a small-sized and lightweight socket, but also provides an enough deformable space and counterforce for the reset spring, making the use and operation of a user simpler and more convenient and making the socket durable.

Preferably, two ends of the reset spring respectively resist against an end portion of the accommodating slot and the convex block; after being mounted, the reset spring is kept in a compressed state at any time; and a direction of a counterforce of the reset spring is a rotating direction for driving the safety door to cover the first through hole.

Through the above structure, to this end, this structural design not only provides a sufficient mounting position for the reset spring in a very narrow space, ensuring that this technical solution is a small-sized and lightweight socket, but also provides an enough deformable space and counterforce for the reset spring, making the use and operation of a user simpler and more convenient and making the socket durable.

Preferably, two ends of the reset spring are respectively fixedly connected to an end portion of the accommodating slot and the convex block; after being mounted, the reset spring is kept in a stretched state at any time; and a direction of a counterforce of the reset spring is a rotating direction for driving the safety door to cover the first through hole.

Through the above structure, the reset spring can alternatively use a tension spring, and the rotating door can be driven by tension. Although the tension mode may be slightly cumbersome for mounting compared to a compression mode, this allows the reset spring to have more cross-sectional shapes for selection. Meanwhile, the accommodating slot may further have more design selections for shapes, such as a tension spring with a rectangular cross section and an accommodating slot with a rectangular cross section.

Preferably, the compatible female socket further includes a wiring unit, wherein the wiring unit is fixedly connected to the conductive clamp; the wiring unit includes:
a wiring frame, wherein the wiring frame is plugged into the first through hole; the conductive clamp is fixedly connected into the wiring frame; and
an end cover, wherein the end cover is fixedly connected to one end of the shell away from the decorative cover; several third through holes aligned with the first through hole are provided on the end cover; and
the third through holes are configured for connection of wires.

Through the above structure, an external wire and the conductive clamp can be tightly fixed together to complete electric connection.

Preferably, a hook is arranged at an outer edge of the end cover; and a hook hole is provided on an outer surface of one side, close to the end cover, of the shell.

Through the above structure, the end cover and the shell are assembled conveniently and firmly, and are not easily loosened. A limiting effect is achieved after assembling, avoiding extrusion of a circuit caused by radial sliding of the end cover after mounting, preventing the power supply efficiency of the circuit from being affected, and avoiding acceleration of the aging speed of the circuit.

Preferably, a mounting hole capable of penetrating through the first through hole is provided on an outer surface of one side, close to the end cover, of the shell; a positioning hole is provided on one side of the wiring frame close to the mounting hole; a portion of one side, close to the end cover, the conductive clamp is U-shaped; and a screw is screwed into the mounting hole to achieve connection of circuits.

Through the above structure, any number of wires can be connected to the socket, so that the socket can adapt to plugs of any specifications and model numbers and then adapt to the assembling of any intelligent terminals. It ensures that the socket has a wide range of application scenes, and the assembling operation for wiring is very simple and convenient.

Preferably, the compatible female socket further includes a pre-buried box, wherein the pre-buried box is pre-buried on a building; and the box body is detachably connected into an embedded part.

Through the above structure, it is not only convenient for the mounting of the common socket, but also convenient for the removal of the common socket. Therefore, for some existing pre-buried boxes on the market, the common socket can be directly assembled with an originally mounted pre-buried box as long as the pre-buried box conforms to the design idea that the socket is detachable. Therefore, for a building where socket mounting has been completed, there is no need to mount the pre-buried box separately, thus further improving the adaptability of the common socket.

Preferably, several threading openings are provided on a surface of the pre-buried box; and detachable stop sheets are arranged in the threading openings.

Through the above structure, it is not only beneficial to prevent mortar from infiltrating the pre-buried box when the pre-buried box is buried into a wall in advance, but also beneficial to directly knock out the detachable stop sheets during subsequent socket wiring to allow external wires to be pulled into the pre-buried box from the threading openings. When used in conjunction with an intelligent terminal, the pre-buried box may further serve as a heat dissipation channel.

Preferably, several limiting convex strips are arranged on an inner wall of the pre-buried box; surfaces of the limiting convex strips facing an opening of the pre-buried box are inclined; and profiled holes matched with the limiting convex strips are provided on the box body.

Through the above structure, when the box body is pushed into the pre-buried box, the limiting convex strips are clamped into the profiled holes, which plays a role in preventing the box body from automatically falling out after the box body is mounted.

Preferably, bent edges are arranged at a rim of the pre-buried box and a rim of the box body.

Through the above structure, a limiting effect is provided for the mounting of the box body into the pre-buried box and the mounting of the pre-buried box into a building, so as to: prevent a surface of the pre-buried box from being embedded in the wall during pouring, and further achieve a limiting effect on the subsequent intelligent terminal, thus avoiding damage to the socket caused by excessive plugging and unplugging forces when a plug is plugged.

Preferably, magnetic suction sheets are arranged at the bent edges.

Through the above structure, during the mounting of the box body into the pre-buried box, the box body automatically slides into the pre-buried box, and a suction force is maintained after the pre-buried box is close to the magnetic suction sheets on the box body, which can improve the firmness of the box body and the pre-buried box to an extent. In an earthquake or when the box body tends to fall out due to a force, the box body can be prevented from falling out or a circuit can be prevented from being stretched, so that electric shock, injury, and the like caused by an accident are avoided.

The present disclosure further provides the following technical solution:

An intelligent concealed box includes the above compatible female socket, and further includes an intelligent male socket. The intelligent male socket includes:
a male plug, wherein the male plug is plugged on the interface unit to achieve electrification; and
a panel, wherein the panel includes but is not limited to a button switch, a display, a touch screen, an intelligent switch, and other terminals.

Compared with the prior art, the present disclosure has the beneficial effects: A high-adaptability socket having a wide range of application scenes is formed, which has the advantages of no wiring and case of mounting. It is convenient for constructing delivered houses with lower decoration costs. In the future market of the socket industry, the present disclosure more easily meets different home decoration style designs, is convenient for adjusting a style, and can be well received by users. Therefore, the socket is easy for marketing and has a good market value.

### BRIEF DESCRIPTION OF THE DRAWINGS

FIG. 1 is a general assembly drawing of a compatible female socket according to the present disclosure;

FIG. 2 is a front view of a structure of a compatible female socket according to the present disclosure;

FIG. 3 is a structural exploded diagram of a compatible female socket according to the present disclosure;

FIG. 4 is a schematic diagram of assembling of a compatible female socket according to the present disclosure;

FIG. 5 is a schematic diagram of assembling of a compatible female socket according to the present disclosure, mainly showing scale lines;

FIG. 6 is a right view of a structure of a compatible female socket according to the present disclosure;

FIG. 7 is a structural exploded diagram of an interface unit in a compatible female socket according to the present disclosure;

FIG. 8 is a schematic diagram of assembling of an interface unit and an adjustment unit in a compatible female socket according to the present disclosure;

FIG. 9 is a schematic diagram of a three-dimensional structure of a safety door in a compatible female socket according to the present disclosure, mainly showing a reset spring;

FIG. 10 is a schematic diagram of a three-dimensional structure of a shell in a compatible female socket according to the present disclosure;

FIG. 11 is a schematic diagram of a three-dimensional structure of a safety door being opened in a compatible female socket according to the present disclosure;

FIG. 12 is a schematic diagram of a three-dimensional structure of a safety door closing a second through hole in a compatible female socket according to the present disclosure;

FIG. 13 is a schematic diagram of a three-dimensional structure of a safety door in a compatible female socket according to the present disclosure;

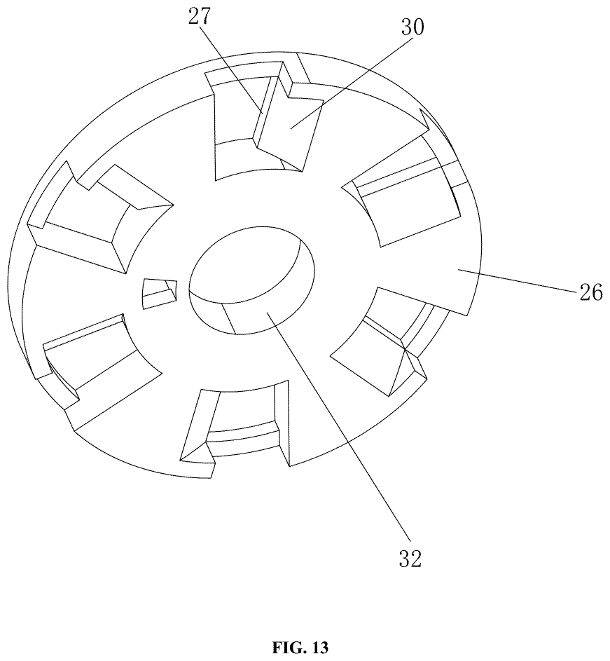

FIG. 14 is a left view of a structure of a box body in a compatible female socket according to the present disclosure, mainly showing a screw hole;

FIG. 15 is a left view of a structure of a box body in a compatible female socket according to the present disclosure, mainly showing a buckle slot;

FIG. 16 is a left view of a structure of a box body in a compatible female socket according to the present disclosure, mainly showing a wiring terminal;

FIG. 17 is a left view of a structure of an intelligent concealed box according to the present disclosure; and

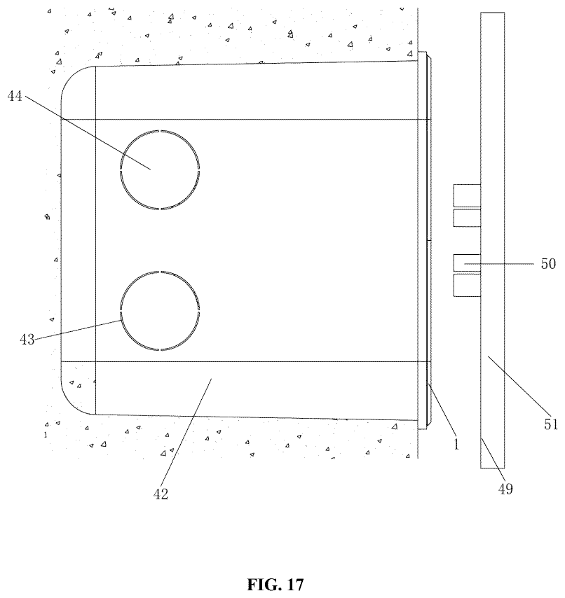

FIG. 18 is a front view of a structure of a compatible female socket according to the present disclosure, mainly showing alignment lines and recesses.

In the drawings: 1: box body; 2: adjustment unit; 3: interface unit; 4: scale line; 5: alignment line; 6: antiskid structure; 7: recess; 8: mounting opening; 9: limiting structure; 10: sliding chute; 11: screw; 12: clamping portion; 13: protrusion; 14: wiring terminal; 15: limiting bracket; 16: screw hole; 17: buckle slot; 18: PCB; 19: shell; 20: decorative cover; 21: first through hole; 22: second through hole; 23: conductive clamp; 24: limiting slot; 25: plugging strip; 26: safety door; 27: penetration opening; 28: avoidance hole; 29: baffle plate; 30: avoidance slot; 31: reset spring; 32: accommodating slot; 33: convex block; 34: wiring unit; 35: wiring frame; 36: end cover; 37: third through hole; 38: hook; 39: hook hole; 40: mounting hole; 41: positioning hole; 42: pre-buried box; 43: threading opening; 44: detachable stop sheet; 45: limiting convex strip; 46: profiled hole; 47: bent edge; 48: magnetic suction sheet; 49: intelligent male socket; 50: male plug; and 51: panel.

### DETAILED DESCRIPTION OF THE EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. Based on the embodiments of the present disclosure, all other embodiments obtained by those of ordinary skilled in the art without creative efforts fall within the protection scope of the present disclosure.

### Embodiment 1

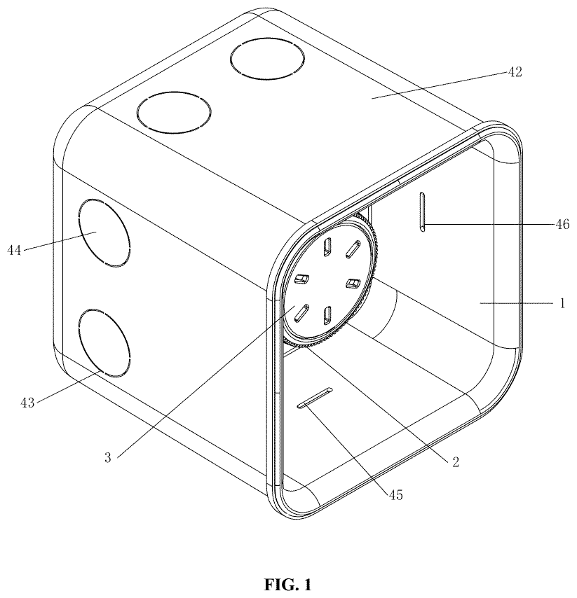

Referring to FIG. 1 to FIG. 3, the present disclosure provides the following technical solution: A compatible female socket includes:
a box body 1;
an adjustment unit 2, wherein the adjustment unit 2 is rotatably connected to one side,
facing an opening of the box body 1, in the box body 1; and
an interface unit 3, wherein one end of the interface unit 3 facing the opening of the box body 1 is configured to connect various external plugs, and the other end of the interface unit 3 is connected to various wires;
the interface unit 3 is slidably connected to the box body 1; the interface unit 3 is in threaded fit with the adjustment unit 2; and the adjustment unit 2 is rotated to drive the interface unit 3 to move.

As an optional implementation solution of the present disclosure, the interface unit 3 is integrated with a power supply wire, and the socket can be connected to a plug of any specification, so that the compatible female socket can be applicable to plugging plugs of most specifications and standards, such as a three-head plug, a two-head plug, a USB, a type-c, and other simple or complicated plugs. The socket can be directly used as a power plug or a data interface and can be directly connected to various electric appliances to supply power or for data transmission, or used as a mounting base and a power supply socket for various switch panels 51. The application range is wide. When the adjustment unit 2 rotates, the interface unit 3 is in sliding connection to and threaded fit with the adjustment unit 2, so that the interface unit 3 can only slide when driven by the rotation of the adjustment unit 2, and the interface unit 3 can move in the box body 1 to be applicable to connecting plugs with flexible cables and connecting direct plugs designed at different positions, which avoids the problem that various plugs cannot be mounted in various intelligent terminals because of different design specifications and sizes of the plugs. Due to the box body 1, the socket can be mounted in a wall together with a pre-buried box 42s and used as a wall-mounted socket, or can be mounted on the ground and used as a floor socket, or can be mounted on some furniture such as a tabletop and a counter. Or, the socket can be mounted in the above scenes without using the pre-buried box 42. Or, some guard structures with dampproof and waterproof functions can be directly designed on the socket, so that the socket can be applied to more scenes.

In this embodiment, an anti-electric shock sticker can be pasted on a surface of the box body 1. If a circuit is damaged or the box body 1 is electrified due to another reason, electric shock caused by touching the box body 1 during use can be prevented, and the safety is improved.

Various mounting structures can be designed on the box body 1. For example, a supporting lug is designed, or a hole is punched on the box body 1, and a screw 11 is driven into the hole, so that the socket can be mounted and fixed in different ways.

The box body 1 can be wired alone or directly wired together with the pre-buried box 42 during water and electricity installation of a building, namely, the common infrastructures are completed at one time, so that socket mounting has been completed in a roughcast house before occupancy, and the overall roughcast house is more beautiful. Therefore, after a user moves into the house, different male sockets are mounted according to an own need. The socket is very easy and convenient to use and operate. Thus, during decoration, the user does not need to mount a socket by the own or ask an electrician to mount a socket, so that lots of decoration costs of the user can be saved.

For existing traditional sockets, a survey is made on intelligent updating renovation costs, door-to-door renovation and debugging costs, and costs for providing additional chargers for traditional sockets. Survey results are as shown in Table 1 to Table 3 below:

TABLE 1
Survey statistics of the intelligent updating and
renovation costs of traditional switch sockets:

| | Intelligent updating and renovation costs | | | | |
|---|---|---|---|---|---|
| Total | of traditional switch sockets (10 years) | | | | |
| number | | Accum- | | Average | Subtotal |
| of | Accum- | ulated | | number of | of |
| home | ulated | number of | Cost of | upgrades | material |
| switch | reno- | renovated | single | and | replace- |
| sockets | vation | switch | switch | renovations | ment |
| (average) | ratio | sockets | socket | (10 years) | costs |
| 50 | 37% | 18.5 | 15 | 3 | 855 RMB |

TABLE 2
Equal apportion survey statistics of door-to-door upgrading renovation and debugging
costs, and costs for providing additional chargers for traditional sockets:

| | | | | Costs for providing additional | | |
|---|---|---|---|---|---|---|
| | | | | chargers for traditional | | |
| | Door-to-door upgrading renovation and | | | sockets (10 years) | | |
| Total number | debugging costs (10 years) | | | Total number | | |
| of home | | | Subtotal of | of home chargers | | |
| switch | | Number of | the costs for | (including those | Cost of | Total |
| sockets | On-site | visits (10 | maintenance | chargers replaced | single | cost of |
| (average) | maintenance | years) | worker | within 10 years) | charger | chargers |
| 50 | 200 RMB/time | 6 | 1200 RMB | 8 | 35 | 280 RMB |

TABLE 3
Survey statistics of the intelligent updating and renovation costs of
traditional switch sockets:

| | | | | Comp- |
|---|---|---|---|---|
| | Intelligent | Cost of | | rehensive |
| Total | renovation | renovation | Unit price | cost of |
| number of | costs of | of | of | upgrading |
| home switch | traditional | single | traditional | renovation of |
| sockets | switch | concealed | concealed | traditional |
| (average) | sockets | box | box | concealed box |
| 50 | 2,335 | 47 RMB/piece | 8 | 55 RMB/piece |

TABLE 4
Statistical analysis of cost of single component of the socket

| Component | Box body | Adjustment unit | Interface unit |
|---|---|---|---|
| Material | Aluminum | PC | PC + |
| | | | aluminum + copper |
| Processing | Mold | Mold opening | Mold opening + |
| way | opening | | bending |

| | |
|---|---|
| Cost | about 20 RMB |

According to the survey results of the intelligent updating renovation costs, the door-to-door renovation and debugging costs, and the costs for providing additional chargers for traditional sockets of the existing traditional sockets in Table 1 to Table 3, in conjunction with the statistic analysis of cost of single component of the socket in Table 4, with respect to the traditional socket, a single family is taken as an example. For the intelligent upgrading renovation, the traditional switch sockets cannot be upgraded and renovated twice to four times due to their positions and functions. According to the intelligent updating renovation costs, the door-to-door renovation and debugging costs, and the costs for providing additional chargers for traditional sockets, excluding the material waste and the environmental governance costs caused by traditional renovation, the comprehensive cost of intelligent upgrading renovation of each traditional concealed box is calculated to be 55 RMB, which exceeds the cost of an intelligent concealed box. The comprehensive cost of the intelligent concealed box that has completed the common infrastructures at one time is 16 RMB/piece lower than the comprehensive cost of upgrading renovation of the traditional intelligent concealed box. After the intelligent concealed box is used, the common base saves the hardware cost for the intelligent terminal (the secondary cost is saved). 150 RMB per single family (calculated as three bedrooms and one living room) is saved for a single terminal, and 5285 RMB has been saved in total. With a cumulative mounting rate of 30% in the next decade, it is estimated that 430 million of families in the whole country can save the comprehensive investment cost by 680 billion RMB. The intelligent concealed box can be directly applied to office and commercial environments. It is expected that a single building will save 1.66 million RMB (calculated based on 10 thousand of intelligent terminals).

Through the above structure, a high-adaptability socket having a wide range of application scenes is formed, which further has the advantages of no wiring and ease of mounting. It is convenient for constructing delivered houses with lower decoration costs. In the future market of the socket industry, the present disclosure more easily meets different home decoration style designs, is convenient for adjusting a style, and can be well received by users. Therefore, the socket is easy for marketing and has a good market value.

### Embodiment 2

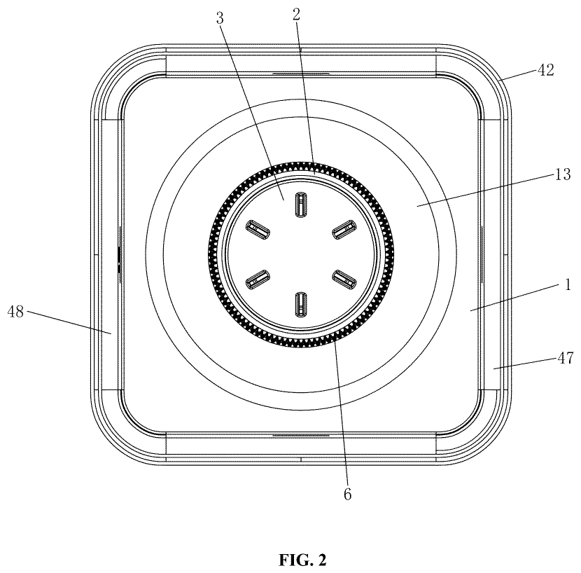

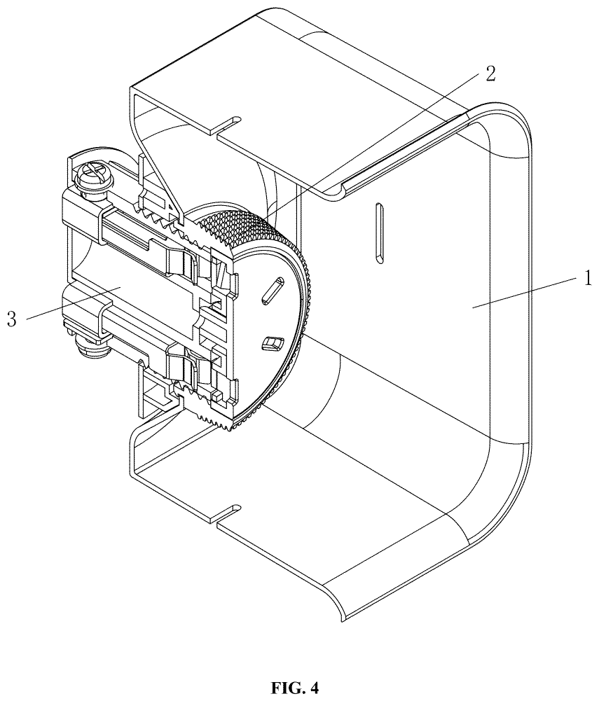

Referring to FIG. 2 to FIG. 4, the present disclosure provides the following technical solution: A compatible female socket includes:
a box body 1, wherein the box body 1 has a protrusion 13 towards an opening of the box body 1; a mounting opening 8 is provided on the protrusion 13; the protrusion 13 is horn-shaped; a limiting bracket 15 is further adhered on a surface of one side, away from the adjustment unit 2, of the protrusion 13; a limiting structure 9 is arranged on a center hole wall of the limiting bracket 15;
an adjustment unit 2, wherein a clamping portion 12 is arranged on an end surface of one end, opposite to the opening of the box body 1, of the adjustment unit 2; a radial section of the clamping portion 12 is L-shaped; the clamping portion 12 is rotatably connected to an inner side of a rim of the mounting opening 8;
an interface unit 3, wherein one end of the interface unit 3 facing the opening of the box body 1 is configured to connect various external plugs, and the other end of the interface unit 3 is connected to various wires; a sliding chute 10 is provided on an outer surface of the interface unit 3 in a moving direction of the interface unit 3; the limiting structure 9 is slidably connected into the sliding chute 10; the interface unit 3 is further in threaded fit with the adjustment unit 2; a thread on the interface unit 3 is arranged at one end, close to the opening of the box body 1, of an outer surface of the interface unit 3; and the adjustment unit 2 is rotated to drive the interface unit 3 to move.

The thread is stopped in front of an edge of an end portion of the interface unit 3, so that the adjustment unit 2 is unable to be screwed out of the interface unit 3. The adjustment unit 2 is made of a plastic part. At least one end of the sliding chute 10 does not penetrate through the thread on the surface of the entire interface unit 3.

As an optional implementation solution of the present disclosure, a mounting position and a moving path are provided for the interface unit 3 through the protrusion 13 and the limiting bracket 15; the entire interface unit 3 is integrated into a very narrow space, which can rival a traditional small-sized and lightweight socket. Compared with a traditional socket, the compatible female socket can achieve a small volume similar to that of a traditional socket switch to adapt to mounting in various mounting requirements, such as a corner, a bottom surface, and a tabletop, and has a function of adjustable mounting of an intelligent terminal device that the traditional socket does not have. Therefore, the compatible female socket has a very wide range of application scenes. Due to the threaded fit between the adjustment unit 2 and the interface unit 3 and the sliding fit between the interface unit 3 and the box body 1, the interface unit 3 can move and will not rotate. This can avoid such a phenomenon that the interface unit 3 cannot move normally because of twining at a wiring end of the interface unit 3, and can further avoid such a phenomenon that an external plug hard connected to an intelligent terminal cannot be plugged into the socket because one end of the interface unit 3 that is configured to be connected to the external plug rotates. To this end, in this technical solution, a high-adaptability common female socket is formed, ensuring that this technical solution has a sufficiently large application scene. A major diameter of the external thread of the interface unit 3 does not exceed an outer diameter of the interface unit 3. In this technical solution, the major diameter of the external thread of the interface unit 3 is preferably equal to the outer diameter of the interface unit 3. This design makes a smaller gap between the entire interface unit 3 and the protrusion 13, as well as between the limiting bracket 15 and the adjustment unit 2, which ensures that the limiting bracket 15 and the sliding chute 10 better abut against each other during assembling, and further ensures that the entire socket can be designed to be small enough to rival the traditional socket. Due to the design of the thread with two ends stopped, the rotation of the adjustment unit 2 drives the interface unit 3 to move to an extreme distance between a front end and a rear end, the interface unit 3 will not be separated from the adjustment unit 2, thus avoiding an operator from performing excessive adjustment to make the interface unit 3 fall off. This design can have a limiting effect on the adjustment performed on the interface unit, thus avoiding excessive pulling and easy damage to a circuit of a wire connected to the interface unit 3. It not only prevents a maintenance trouble caused by a broken circuit, but also prevents the risk of easy electric shock around the socket due to the broken circuit, thereby improving the safety of the socket during use. Moreover, the trouble and risk of reassembling the interface unit 3 into the socket due to an error in the adjustment operation can be prevented. The adjustment unit 2 made of the plastic part has an elasticity. When assembled on the thread with two ends stopped, the adjustment unit can have a slight elastic deformation to ensure that the adjustment unit 2 can be assembled with the interface unit 3. Meanwhile, this further ensures that the clamping portion 12 is elastic and can be clamped to the mounting opening 8, so that the entire adjustment unit 2 can be mounted in the protrusion 13 and the limiting bracket 15 after being assembled with the interface unit 3. Moreover, the adjustment unit 2 made of the plastic part further has the advantages of insulation and low cost, which can improve the safety of the adjustment operation and reduce the cost of the entire socket.

In this embodiment:

An inner diameter of a front end of the adjustment unit 2 and an inner diameter of the clamping portion 12 should not be less than a major diameter of an internal thread on the adjustment unit 2, so as to ensure that the front end of the adjustment unit 2 and the clamping portion 12 will not hinder the movement of the interface unit 3 when the internal thread on the adjustment unit 2 moves to the middle of the external thread on the interface unit 3

To ensure that the adjustment unit 2 and the interface unit 3 which are integrally assembled can be mounted on the protrusion 13, the inner diameter of the clamping portion 12 shall be further greater than the major diameter of the internal thread on the adjustment unit 2 to make ensure that the clamping portion 12 has a space for deformation and the clamping portion 12 can be clamped onto the mounting opening 8.

The clamping portion 12 can be designed into a right trapezoid. In this way, the clamping portion 12 can be ensured to be easily mounted in the mounting opening 8, and after the adjustment unit 2 is mounted into the mounting opening 8, it is difficult for the adjustment unit 2 to be separated from the mounting opening. This makes the adjustment unit 2 and the box body 1 mounted at high firmness, preventing damage to the entire socket caused by the separation of the adjustment unit 2 from the mounting opening 8 due to an excessive plugging force on an external plug, and ensuring that this socket product has sufficient quality assurance.

For the adjustment unit 2, the internal thread and an outer layer of the adjustment unit 2 can be separately manufactured. Specifically, they are separately designed into an elastic ring component with an internal thread and an outer layer ring without an internal thread. During assembling, the elastic ring is first mounted on the interface unit 3 to achieve threaded fit, and an axial surface of the elastic ring is then coated with glue or a double-faced adhesive tape; the outer layer ring sleeves the elastic ring to form the overall adjustment unit 2; and the adjustment unit 2 is slightly pushed to clamp the clamping portion 12 to the mounting opening 8. This design mode is much easier than the mode of making the entire adjustment unit 2 undergo elastic deformation. The working procedures are complex, but it is labor-saving for mounting.

For the sliding chute 10, at least one end of which does not penetrate through the thread on the surface of the entire interface unit 3, if a diameter of a decorative cover 20 is greater than the major diameter of the adjustment unit 2, it is preferred that a rear end of a shell 19 is not perforative, so that the shell 19 can be avoided from being completely separated from the adjustment unit 2, thus avoiding excessive pulling and easy damage to a circuit of a wire connected to the interface unit 3. It not only prevents a maintenance trouble caused by a broken circuit, but also prevents the risk of easy electric shock around the socket due to the broken circuit, thereby improving the safety of the socket during use. Moreover, the trouble and risk of reassembling the interface unit 3 into the socket due to an error in the adjustment operation can be prevented.

Through the above structure, a compact socket having low cost, a small size, a light weight, a large range of application scenes, high adaptability, and ease, convenience, and safety of use and operation, is maintenance-free, and is easy to assemble and disassemble is formed.

### Embodiment 3

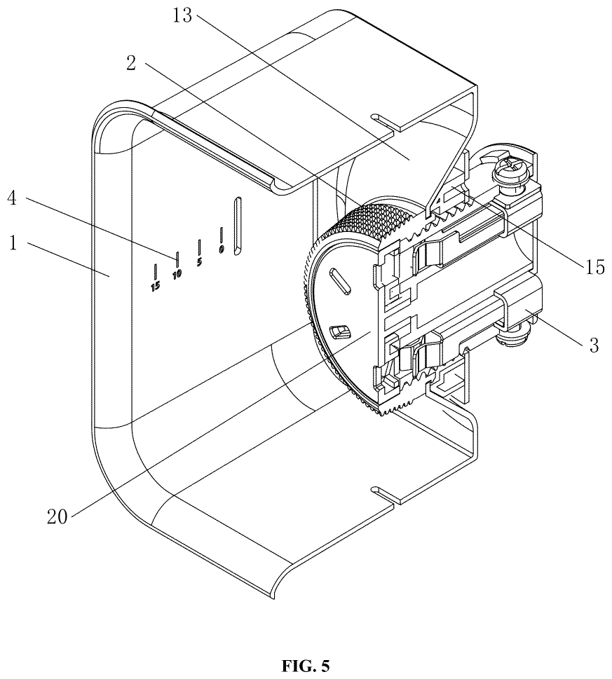

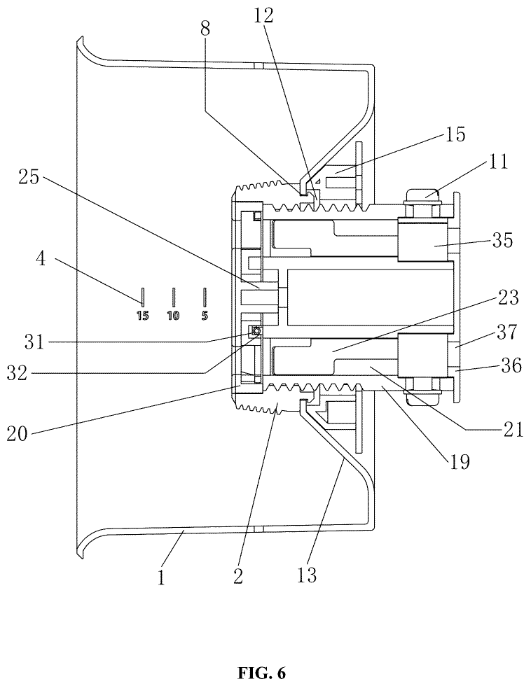

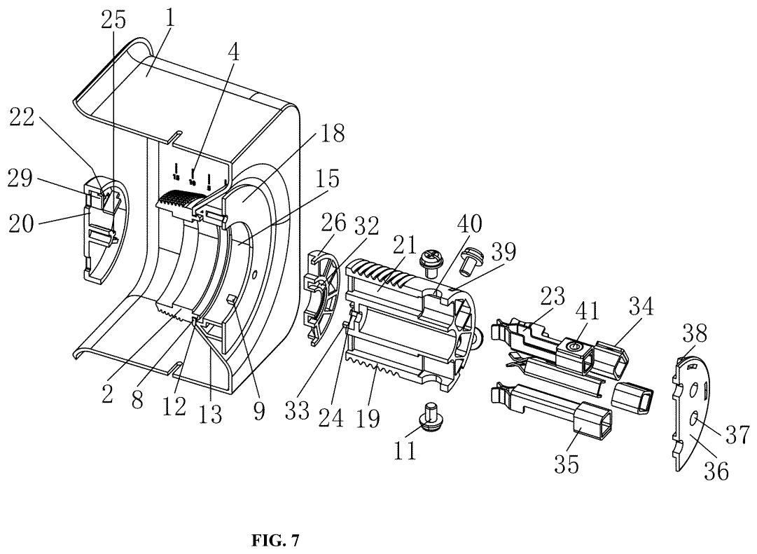

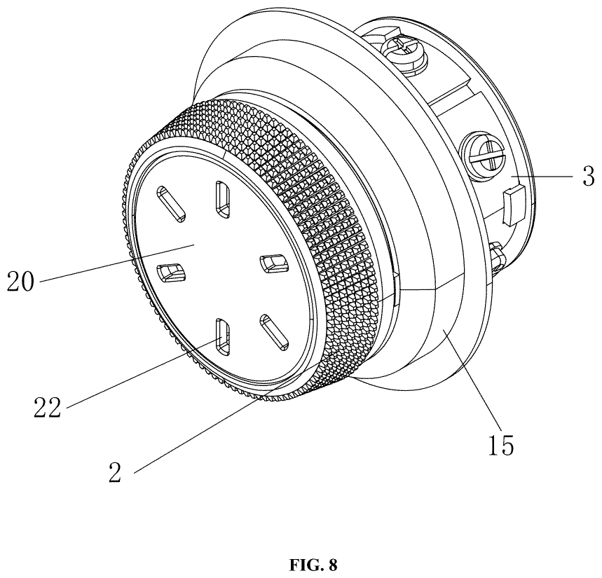

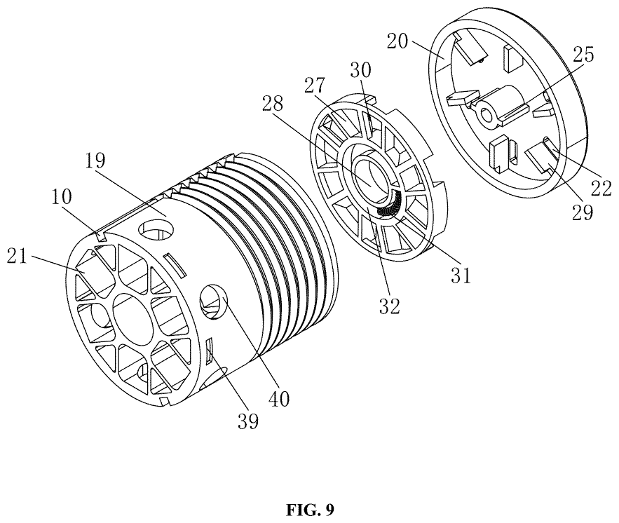

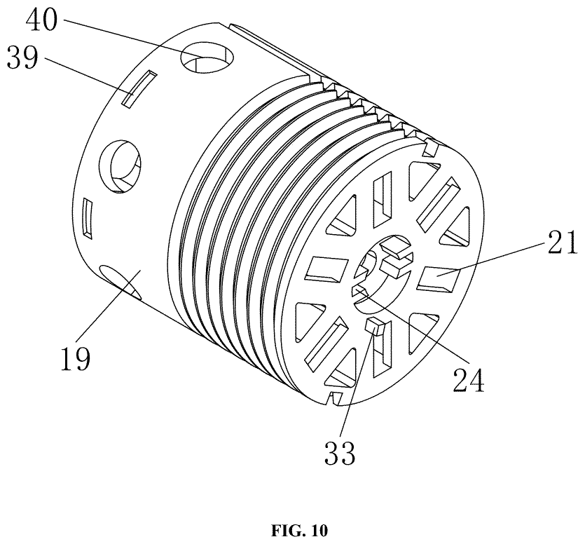

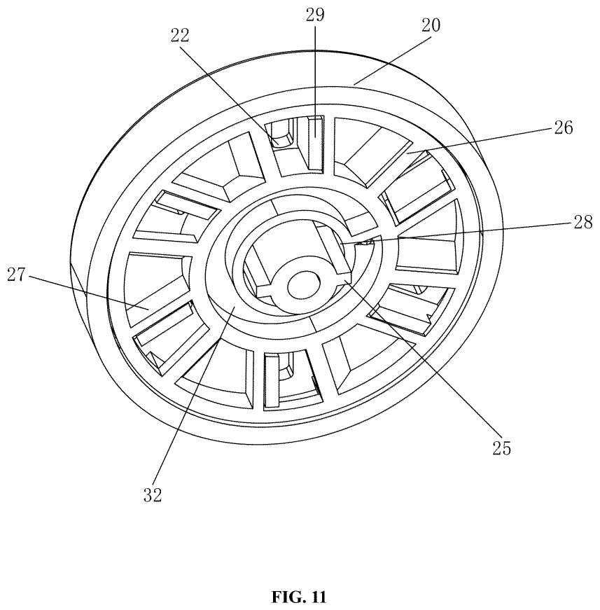

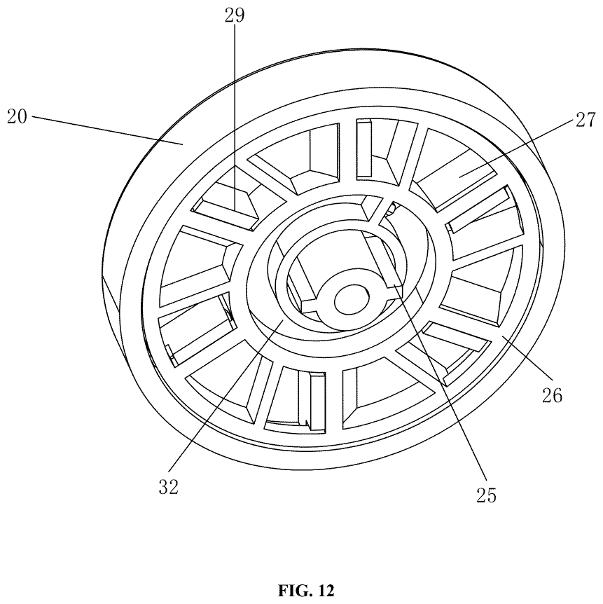

Referring to FIG. 2 to FIG. 12, the present disclosure provides the following technical solution: A compatible female socket includes a box body 1, an adjustment unit 2, and an interface unit 3. The adjustment unit 2 is rotatably connected to one side, facing an opening of the box body 1, in the box body 1.

The interface unit 3 includes a shell 19 and a decorative cover 20. A thread matched with the adjustment unit 2 is provided on a surface of the shell 19; the shell 19 is slidably connected into the adjustment unit 2; and the adjustment unit 2 is rotated to drive the interface unit 3 to move.

A limiting slot 24 which is arranged in a moving direction of the interface unit 3 is provided on an inner wall of the shell 19; and a plugging strip 25 matched with the limiting slot 24 is arranged on one side of the decorative cover 20 close to the shell 19, so that the decorative cover 20 can be plugged on an end surface of the shell 19 facing the opening of the box body 1. A first through hole 21 is provided inside the shell 19; a conductive clamp 23 configured to be connected to various wires is fixedly connected into the first through hole 21; a second through hole 22 configured to connect various external plugs is provided on the decorative cover 20; and the second through hole 22 is aligned with the first through hole 21.

A safety door 26 is rotatably connected into the decorative cover 20 and between the decorative cover 20 and the shell 19; several penetration openings 27 aligned with the first through hole 21 are provided on the safety door 26; and an avoidance hole 28 for allowing the plugging strip 25 to pass through is further provided on the safety door 26. A baffle plate 29 is arranged at one end of the decorative cover 20 close to the safety door 26 and one side of the decorative cover located in the second through hole 22; when the safety door 26 is mounted at the decorative cover 20, the baffle plate 29 is located in the penetration openings 27; an avoidance slot 30 that is able to accommodate the baffle plate 29 is provided on one side wall surface of the safety door 26 located at the penetration openings 27; and the avoidance slot 30 is inclined or arc-shaped.

An arc-shaped accommodating slot 32 is provided on an end surface of the safety door 26 close to the shell 19; a reset spring 31 is arranged in the accommodating slot 32; and a convex block 33 capable of extending into the accommodating slot 32 is arranged on an end surface of the shell 19 close to the safety door 26. Two ends of the reset springs 31 respectively resist against an end portion of the accommodating slot 32 and the convex block 33. After being mounted, the reset spring 31 is kept in a compressed state at any time; and a direction of a counterforce of the reset spring 31 is a rotating direction for driving the safety door 26 to cover the first through hole 21. When no external plug is plugged into the interface unit 3 through the elasticity of the reset spring 31, the safety door 26 is kept in a state of blocking the first through hole 21 and the second through hole 22.

As an optional implementation solution of the present disclosure, through the arrangement of the decorative cover 20, the shell 19, and a wire clamp, a basic socket core structure is formed. During assembling, only the wire clamp needs to be plugged into the first through hole 21 on the shell 19, and the plugging strip 25 is plugged into the limiting slot 24 on the end surface of the shell 19, thus mounting the decorative cover 20. Therefore, this structural design makes the assembling operation simple and convenient, and the labor can be saved. Furthermore, when a corresponding assembling device is designed for this technical solution, all the components in this technical solution have simple appearances, and the assembling procedure is simple, so that the corresponding assembling device is easier to design, which contributes to improving the promotion speed of this socket product on the market, and this socket product can meet the market requirement more easily compared with the traditional socket, which can further improve the promotion speed of the Internet of things on the market. Thus, the popularization of the advanced technology such as the Internet of things in the fields such as smart parks, smart communities, smart offices, smart campuses, smart old-age care, smart medical care, and smart manufacturing and the development of the social economy are accelerated. Through the rotation of the safety door 26 between the shell 19 and the decorative cover 20, the second through hole 22 and the first through hole 21 can be blocked and unblocked. Therefore, after the overall mounting of the socket is completed and before an external plug is plugged, an external non-plug item or a living object cannot enter the decorative cover 20 and the shell 19. This can avoid a safety accident of electric shock caused by human touch, and especially prevent naughty children from sticking their fingers into the socket. This can further reduce the entry of dust, impurities, and other foreign objects that may affect the power supply efficiency of the socket and lower the difficulty of wiping and maintenance, thereby improving the usability and safety of the socket and reducing the maintenance cost of the socket. Further, the reset spring 31 is arranged between the safety door 26 and the shell 19, so that after the plug is pulled out, the safety door 26 automatically covers the first through hole 21 and the second through hole 22 when there is no external plug being plugged into the socket. When an external plug is plugged, the plug moves directly along a surface of the avoidance slot 30 to drive the safety door 26 to rotate, so that the first through hole 21 and the second through hole 22 are connected to enable the external plug to be plugged. To this end, this structural design not only provides a sufficient mounting position for the reset spring 31 in a very narrow space, ensuring that this technical solution is a small-sized and lightweight socket, but also provides an enough deformable space and counterforce for the reset spring 31, making the use and operation of a user simpler and more convenient and making the socket durable.

In this embodiment: the shell 19, the safety door 26, and the decorative cover 20 can be all made of a plastic material, so that the socket has a light weight and low manufacturing costs. It is very convenient for batch mold opening, forming, and processing. The socket further has good insulation property to ensure that a safety accident caused by the fact that a user touches a power supply by mistake during use can be avoided.

The plugging strip 25 on the decorative cover 20 and the limiting slot 24 in the shell 19 further have an anti-separation design, such as elastic damping, interference fit, and buckle design, to ensure that the shell 19 and the decorative cover 20 of the socket are firm after mounting. The shell 19 and the decorative cover 20 will not be loosened in spite of the adjustment, thereby avoiding separation of the safety door 26 caused by no limitation on the safety door because the decorative cover 20 is loosened and even falls off, preventing the entire core structure of the socket from falling off, and ensuring the effective adjustability of the socket. Furthermore, this design improves the leakproofness of the safety door 26, ensures that external impurities cannot enter the socket, and has outstanding beneficial effects.

After being mounted, two ends of the safety door 26 are in close contact with an end surface of the shell 19 and an inner wall of the decorative cover 20. Therefore, both the first through hole 21 and the second through hole 22 can be thoroughly blocked, ensuring that it is hard for external dust, impurities, and wet air to enter the shell 19 through the second through hole 22, avoiding accelerated aging and even short circuits and damage due to the impact of the dust, the impurities, and the wet air on the inside of the socket, further improving the durability of the present disclosure, and prolonging the service life of the socket, so that the repair and maintenance costs of a user can be greatly reduced, and the popularity degree of the socket on the market can be improved.

The number of the first through hole 21 on the shell 19 and the second through hole 22 on the decorative cover 20 are equal and are not less than one, so that the first through hole and the second through hole can be annularly distributed, or can be designed according to the standard of other plugs. Each wire clamp can be connected to a null wire, a fire wire, a ground wire, or any wire connected to modules with different functions. The shapes of all the through holes can be of any specification, as long as wire clamps in various styles can be mounted into the shell 19, and a plug that is sheetlike, or cylindrical, or in any specification and shape can be directly plugged into the socket, ensuring that the socket has sufficiently high compatibility and a wide range of application scenes.

Through the above structure, a high-compatibility socket having a small size, high safety, low maintenance difficulty, and durability is formed.

### Embodiment 4

Referring to FIG. 1 to FIG. 12, the present disclosure provides the following technical solution: A compatible female socket includes a box body 1, an adjustment unit 2, and an interface unit 3. The interface unit 3 includes a shell 19, a decorative cover 20, and a wiring unit 34. The adjustment unit 2 is rotatably connected to one side, facing an opening of the box body 1, in the box body 1. A thread matched with the adjustment unit 2 is provided on a surface of the shell 19; the shell 19 is slidably connected into the adjustment unit 2; and the adjustment unit 2 is rotated to drive the interface unit 3 to move. The wiring unit 34 includes a wiring frame 35 and an end cover 36.

A first through hole 21 is provided inside the shell 19; the wiring frame 35 is plugged into the first through hole 21; a conductive clamp 23 configured to be connected to various wires is fixedly connected into the wiring frame 35; the decorative cover 20 is plugged onto an end surface of the shell 19 facing the opening of the box body 1; a second through hole 22 configured to connect various external plugs is provided on the decorative cover 20; and the second through hole 22 is aligned with the first through hole 21.

The end cover 36 is fixedly connected to one end of the shell 19 away from the decorative cover 20. Several third through holes 37 aligned with the first through hole 21 are provided on the end cover 36; and the third through holes 37 are configured for connection of wires. A mounting hole 40 capable of penetrating through the first through hole 21 is provided on an outer surface of one side, close to the end cover 36, of the shell 19; a positioning hole 41 is provided on one side of the wiring frame 35 close to the mounting hole 40; a portion of one side, close to the end cover 36, of the conductive clamp 23 is U-shaped; and a screw 11 is screwed into the mounting hole 40 to achieve connection of circuits.

A hook 38 is arranged at an outer edge of the end cover 36; and a hook hole 39 is provided on the outer surface of the side, close to the end cover 36, of the shell 19.

As an optional implementation solution of the present disclosure, the conductive clamp 23 is plugged into the wiring frame 35, and the wiring frame 35 and the conductive clamp 23 are overall plugged into the first through hole 21. External wires pass through the end cover 36 via the third through holes 37 and are placed in the conductive clamp 23, and the screw 11 is screwed into the mounting hole 40 and the positioning hole 41. The external wires and the conductive clamp 23 are tightly fixed together to complete electric connection. In this design, any number of wires can be connected to the socket, so that the socket can adapt to plugs of any specifications and model numbers and then adapt to the assembling of any intelligent terminals. It ensures that the socket has a wide range of application scenes, and the assembling operation for wiring is very simple and convenient. The hook 38 on the end cover 36 is clamped onto the hook hole 39, and the alignment between the third through holes 37 and the first through holes 21 and the fixed connection between the end cover 36 and the shell 19 are achieved. In this assembling mode, the end cover 36 and the shell 19 are assembled conveniently and firmly, and are not easily loosened. A limiting effect is achieved after assembling, avoiding extrusion of a circuit caused by radial sliding of the end cover 36 after mounting, preventing the power supply efficiency of the circuit from being affected, and avoiding acceleration of the aging speed of the circuit.

In this embodiment:

Bosses matched with the first through holes 21 are further arranged on one side of the end cover 36 close to the shell 19. The third through holes 37 are provided in the bosses, which can further ensure that the end cover 36 and the shell 19 can be connected more tightly and firmly, to ensure that no radial and axial movements occur between the end cover 36 and the shell 19 after mounting.

The hook 38 on the end cover 36 can alternatively enter the shell 19 to achieve connection to the hook hole 39 on the shell 19.

Through the above structure, a socket that is easy and convenient to wire and assemble and can be applied to plugs of any specification and model number after being assembled is formed. The socket has a wide range of application scenes.

### Embodiment 5

Referring to FIG. 1, the present disclosure provides the following technical solution: A compatible female socket includes:
a box body 1;
an adjustment unit 2, wherein the adjustment unit 2 is rotatably connected to one side, facing an opening of the box body 1, in the box body 1;
an interface unit 3, wherein one end of the interface unit 3 facing the opening of the box body 1 is configured to connect various external plugs, and the other end of the interface unit 3 is connected to various wires; and
a pre-buried box 42, wherein the pre-buried box 42 is pre-buried on a building; and the box body 1 is detachably connected into an embedded part.

The interface unit 3 is slidably connected to the box body 1; the interface unit 3 is in threaded fit with the adjustment unit 2; and the adjustment unit 2 is rotated to drive the interface unit 3 to move.

As an optional implementation solution of the present disclosure, the pre-buried box 42 is mounted on a wall of a building in advance. This is consistent with most of the current solution of placing a junction box in advance for facilitating subsequent wiring and mounting of sockets. The significance of detachable connection between the box body 1 and the pre-buried box 42 is that it is not only convenient for the mounting of the common socket, but also convenient for the removal of the common socket. Therefore, for some existing pre-buried boxes 42 on the market, the common socket can be directly assembled with an originally mounted pre-buried box 42 as long as the pre-buried box conforms to the design idea that the socket is detachable. Therefore, for a building where socket mounting has been completed, there is no need to mount the pre-buried box 42 separately, thus further improving the adaptability of the common socket.

In this embodiment, an axial section of the pre-buried box 42 can be circular, square, triangular, or polygonal. In this technical solution, the axial section can be preferably square, but the above shape and specification can be adjusted according to an actual need.

### Embodiment 6

Referring to FIG. 1 to FIG. 2, the present disclosure provides the following technical solution: A compatible female socket includes:
a box body 1;
an adjustment unit 2, wherein the adjustment unit 2 is rotatably connected to one side, facing an opening of the box body 1, in the box body 1; and
an interface unit 3, wherein one end of the interface unit 3 facing the opening of the box body 1 is configured to connect various external plugs, and the other end of the interface unit 3 is connected to various wires; the interface unit 3 is slidably connected to the box body 1; the interface unit 3 is further in threaded fit with the adjustment unit 2; the adjustment unit 2 is rotated to drive the interface unit 3 to move; and
a pre-buried box 42, wherein the pre-buried box 42 is pre-buried on a building; and the box body 1 is detachably connected into an embedded part.

Several threading openings 43 are provided on a surface of the pre-buried box 42; and detachable stop sheets 44 are arranged in the threading openings 43. Several limiting convex strips 45 are arranged on an inner wall of the pre-buried box 42; surfaces of the limiting convex strips 45 facing an opening of the pre-buried box 42 are inclined; and profiled holes 46 matched with the limiting convex strips 45 are provided on the box body 1. Bent edges 47 are arranged at a rim of the pre-buried box 42 and a rim of the box body 1. Magnetic suction sheets 48 are arranged at the bent edges 47.

As an optional implementation solution of the present disclosure, there are only a few of connection points between the detachable stop sheets 44 on the pre-buried box 42 and the pre-buried box 42. Furthermore, a gap between the detachable stop sheets 44 and the pre-buried box 42 is small, and the detachable stop sheets are manufactured during production and only need to be knocked out slightly during mounting. In this design, it is not only beneficial to prevent mortar from infiltrating the pre-buried box 42 when the pre-buried box 42 is buried into a wall in advance, but also beneficial to directly knock out the detachable stop sheets 44 during subsequent socket wiring to allow external wires to be pulled into the pre-buried box 42 from the threading openings 43. When used in conjunction with an intelligent terminal, the pre-buried box may further serve as a heat dissipation channel. When the box body 1 is pushed into the pre-buried box 42, the limiting convex strips 45 are clamped into the profiled holes 46, which plays a role in preventing the box body from automatically falling out after the box body 1 is mounted. Due to the magnetic suction sheets 48, during the mounting of the box body 1 into the pre-buried box 42, the box body automatically slides into the pre-buried box 42, and a suction force is maintained after the pre-buried box 42 is close to the magnetic suction sheets 48 on the box body 1, which can improve the firmness of the box body 1 and the pre-buried box 42 to an extent. In an earthquake or when the box body 1 tends to fall out due to a force, the box body 1 can be prevented from falling out or a circuit can be prevented from being stretched, so that electric shock, injury, and the like caused by an accident are avoided.

In this embodiment, the threading openings 43 and the detachable stop sheets 44 can be designed into different shapes and quantities, which are not specifically limited in this technical solution.

This technical solution will not specifically limit the shape, number, and specific design position of the limiting convex strips 45.

The bent edges 47 provide a limiting effect for the mounting of the box body 1 into the pre-buried box 42 and the mounting of the pre-buried box 42 into a building, so as to: prevent a surface of the pre-buried box 42 from being embedded in the wall during pouring, and further achieve a limiting effect on the subsequent intelligent terminal, thus avoiding damage to the socket caused by excessive plugging and unplugging forces when a plug is plugged.

The magnetic suction sheets 48 can be specifically arranged in the pre-buried box 42 and/or the box body 1. This technical solution will not specifically limit the number and specification of the magnetic suction sheets 48 in which component.

Through the above structure, a socket that is convenient for on-site construction and facilitates subsequent wiring is formed. Use of this socket is favorable to electrical construction, thereby ensuring that this socket will not delay the delivery of a roughcast house, so that the construction party favors this socket. This socket product is market-oriented and is very easy to promote.

### Embodiment 7

The present disclosure provides the following technical solution: A compatible female socket includes:
a box body 1, wherein the box body 1 has a protrusion 13 towards an opening of the box body 1, and the protrusion 13 is provided with a mounting opening 8;
an adjustment unit 2, wherein the adjustment unit 2 is rotatably connected to an inner side of a rim of the mounting opening 8 through a bearing; and
an interface unit 3, wherein one end of the interface unit 3 facing the opening of the box body 1 is configured to connect various external plugs, and the other end of the interface unit 3 is connected to various wires.

The interface unit 3 is slidably connected to the box body 1; the interface unit 3 is in threaded fit with the adjustment unit 2; and the adjustment unit 2 is rotated to drive the interface unit 3 to move.

As an optional implementation solution of the present disclosure, through the bearing, the rotation of the adjustment unit 2 can reduce the friction between the adjustment unit 2 and the mounting opening 8, making the adjustment more sensitive.

In this embodiment, the protrusion 13 can be tubular or horn-shaped, which will not be specifically limited in this technical solution.

An anti-separation design needs to be performed on the mounting opening 8 and the bearing. A specific mode includes but is not limited to: designing an edge of the clamping portion 12 into an end surface that can cover the entire bearing or directly fixing an outer ring and inner ring of the bearing to the connected component by adhesion. In this way, the adjustment unit 2 and the box body 1 are mounted at high firmness, preventing damage to the entire socket caused by the separation of the adjustment unit 2 from the mounting opening 8 due to an excessive plugging force on an external plug, and ensuring that this socket product has sufficient quality assurance.

### Embodiment 8

The present disclosure provides the following technical solution: A compatible female socket includes:

a box body 1, wherein the box body 1 has a protrusion 13 towards an opening of the box body 1, and the protrusion 13 is provided with a mounting opening 8;
an adjustment unit 2, wherein the adjustment unit 2 is rotatably connected to an outer side of a rim of the mounting opening 8; and
an interface unit 3, wherein one end of the interface unit 3 facing the opening of the box body 1 is configured to connect various external plugs, and the other end of the interface unit 3 is connected to various wires.

The interface unit 3 is slidably connected to the box body 1; the interface unit 3 is in threaded fit with the adjustment unit 2; and the adjustment unit 2 is rotated to drive the interface unit 3 to move.

As an optional implementation solution of the present disclosure, the adjustment unit 2 may alternatively be mounted on the outer side of the mounting opening 8. As the mounting opening 8 protrudes towards a center line of the box body 1 and inwards sunken towards an inner wall of the box body 1, or as a rim of the mounting opening 8 directly protrudes outwards at an edge of the protrusion 13, the clamping portion 12 is clamped in the mounting opening 8 from the outside of the mounting opening 8. This design has the advantages that there is a larger space in the interface unit 3 for the mounting of the adjustment unit 2. When the interface unit 3 needs to be connected to a plug with more wiring terminals, a shell 19 with more first through holes 21 needs to be used. At this time, a diameter of the shell 19 may be larger, so that this technical solution can adapt to the mounting of the adjustment unit 2 that requires a larger mounting space.

In this embodiment, the mounting opening 8 can alternatively be an inwards and outwards protruding structure. Meanwhile, a limiting structure 9 on a protrusion 13 can be detachable or telescopic, so that the adjustment unit 2 can be externally connected to the mounting opening 8, and the adjustment unit 2 can be mounted on the mounting opening 8 from an inner edge, to ensure the effective adjustability of the entire interface unit 3 and further increase the range of application scenes of the socket.

### Embodiment 9

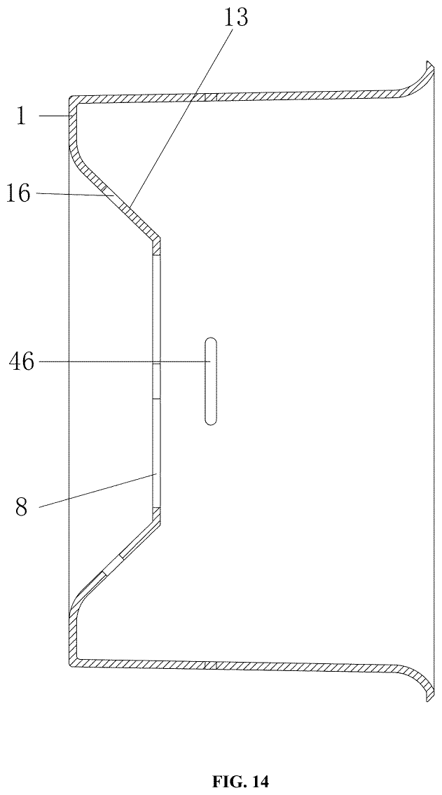

Referring to FIG. 14, the present disclosure provides the following technical solution: A compatible female socket includes:
a box body 1, wherein the box body 1 is provided with a protrusion 13 towards an opening of the box body 1, and the protrusion 13 is provided with a mounting opening 8;
an adjustment unit 2, wherein the adjustment unit 2 is rotatably connected to the mounting opening 8; and
an interface unit 3, wherein one end of the interface unit 3 facing the opening of the box body 1 is configured to connect various external plugs, and the other end of the interface unit 3 is connected to various wires.

One side of the protrusion 13 away from the adjustment unit 2 is fixedly connected with a limiting bracket 15. A limiting structure 9 parallel to a moving direction of the interface unit 3 is arranged on a center hole wall of the limiting bracket 15; a sliding chute 10 is provided on an outer surface of the interface unit 3; and the limiting structure 9 is slidably connected into the sliding chute 10. The interface unit 3 is in threaded fit with the adjustment unit 2. The adjustment unit 2 is rotated to drive the interface unit 3 to move.

A clamping portion 12 is arranged on an end surface of one end, opposite to the opening of the box body 1, of the adjustment unit 2; the clamping portion 12 is matched with a rim of the mounting opening 8; and a radial section of the clamping portion 12 is L-shaped.

Several screw holes 16 are provided on a surface of the protrusion 13; and screws 11 are screwed into the screw holes 16 to fix the limiting bracket 15.

As an optional implementation solution of the present disclosure, this technical solution mainly aims at the mounting mode of the limiting bracket 15. The limiting bracket 15 is fixedly connected to the protrusion 13 through a thread, which has the advantages that when an internal circuit of this socket generates a large amount of heat or the heat of an external intelligent terminal diffuses into the box body 1, it is hard for the limiting bracket 15 to be loosened and even separated due to the fact that glue is heated to be melted.

In this embodiment, the protrusion 13 can be horn-shaped or tubular. The limiting bracket 15 can be mounted on an inner wall of the protrusion 13, and the screws 11 are screwed, or can be mounted on a bottom plane of the box body 1.

### Embodiment 10

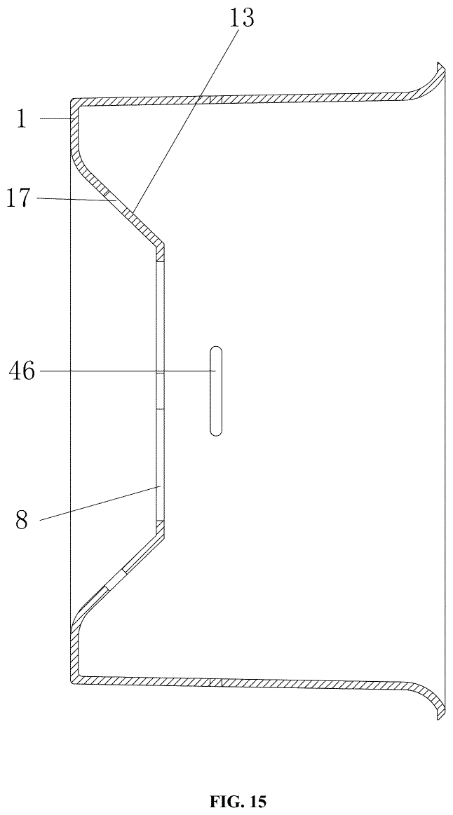

Referring to FIG. 15, the present disclosure provides the following technical solution: A compatible female socket includes:
a box body 1, wherein the box body 1 is provided with a protrusion 13 towards an opening of the box body 1, and the protrusion 13 is provided with a mounting opening 8;
an adjustment unit 2, wherein the adjustment unit 2 is rotatably connected to the mounting opening 8; and
an interface unit 3, wherein one end of the interface unit 3 facing the opening of the box body 1 is configured to connect various external plugs, and the other end of the interface unit 3 is connected to various wires.

One side of the protrusion 13 away from the adjustment unit 2 is fixedly connected with a limiting bracket 15. A limiting structure 9 parallel to a moving direction of the interface unit 3 is arranged on a center hole wall of the limiting bracket 15; a sliding chute 10 is provided on an outer surface of the interface unit 3; and the limiting structure 9 is slidably connected into the sliding chute 10. The interface unit 3 is in threaded fit with the adjustment unit 2. The adjustment unit 2 is rotated to drive the interface unit 3 to move.

A clamping portion 12 is arranged on an end surface of one end, opposite to the opening of the box body 1, of the adjustment unit 2; the clamping portion 12 is matched with a rim of the mounting opening 8; and a radial section of the clamping portion 12 is L-shaped.

Several buckle slots 17 are provided on a surface of the protrusion 13 opposite to the opening of the box body 1; and buckles matched with the buckle slots 17 are arranged on a surface of one side, close to the protrusion 13, of the limiting bracket 15.

As an optional implementation solution of the present disclosure, this technical solution mainly aims at the mounting off the limiting bracket 15. The limiting bracket 15 can be detachably mounted and connected to the protrusion 13 by plugging the buckles into the buckle slots. This mode has the advantages that the mounting of the limiting bracket 15 can be quickly completed. It is faster than a thread mode, and the glue will not be melted due to the high heat of the socket.

In this embodiment, the buckle slots 17 are distributed on the protrusion 13 in a circular array manner. In this design, the limiting bracket 15 has more stress points. After mounting, radial slippage occurs more hardly; falling of the limiting bracket 15 caused by the buckles being separated from the buckle slots 17 due to the rotation of the interface unit 3 is avoided; and a failure of the adjustability of the socket can be prevented.

### Embodiment 11

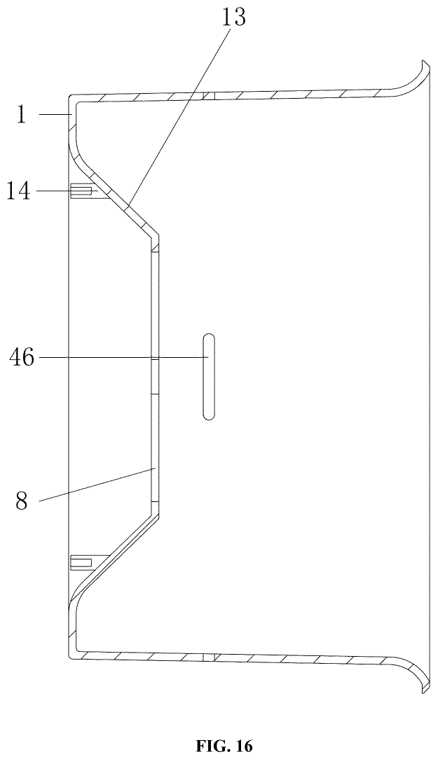

Referring to FIG. 16, the present disclosure provides the following technical solution: A compatible female socket includes:
a box body 1, wherein the box body 1 is provided with a protrusion 13 towards an opening of the box body 1, and the protrusion 13 is provided with a mounting opening 8;
an adjustment unit 2, wherein the adjustment unit 2 is rotatably connected to the mounting opening 8; and
an interface unit 3, wherein one end of the interface unit 3 facing the opening of the box body 1 is configured to connect various external plugs, and the other end of the interface unit 3 is connected to various wires.

Several wiring terminals 14 are arranged on one side of the protrusion 13 away from an orientation of the opening of the box body 1; a limiting bracket 15 is fixedly mounted on the wiring terminals 14; a limiting structure 9 parallel to a moving direction of the interface unit 3 is arranged on a center hole wall of the limiting bracket 15; a sliding chute 10 is provided on an outer surface of the interface unit 3; and the limiting structure 9 is slidably connected into the sliding chute 10. The interface unit 3 is in threaded fit with the adjustment unit 2. The adjustment unit 2 is rotated to drive the interface unit 3 to move.

A clamping portion 12 is arranged on an end surface of one end, opposite to the opening of the box body 1, of the adjustment unit 2; the clamping portion 12 is matched with a rim of the mounting opening 8; and a radial section of the clamping portion 12 is L-shaped.

As an optional implementation solution of the present disclosure, the limiting bracket 15 is mounted through the wiring terminals 14. This fixing mode has the advantages that this socket has the characteristic that the limiting bracket 15 mounted through a screw 11 is detachable and has better firmness, and a subsequent mounting position is provided for a printed circuit board (PCB) 18, so that the PCB 18 is mounted on the limiting bracket 15 and the box body 1 more tightly and firmly, and the occupied space is small.

### Embodiment 12

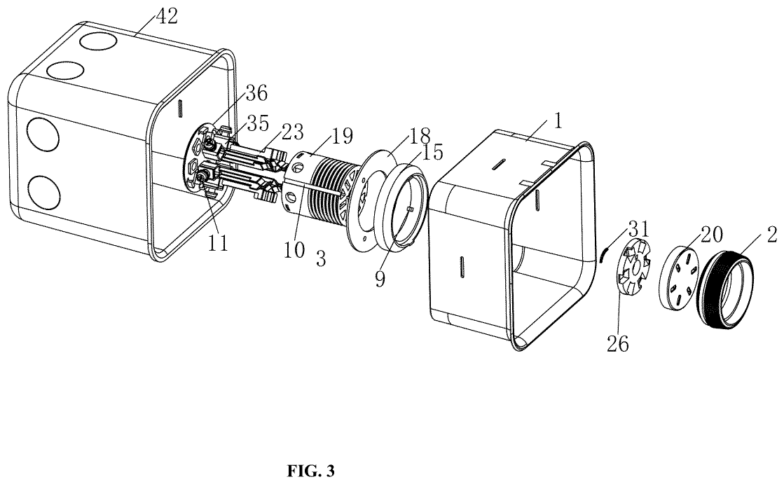

Referring to FIG. 3, the present disclosure provides the following technical solution: A compatible female socket includes:
a box body 1;
an adjustment unit 2, wherein the adjustment unit 2 is rotatably connected to one side, facing an opening of the box body 1, in the box body 1; and
an interface unit 3, wherein one end of the interface unit 3 facing the opening of the box body 1 is configured to connect various external plugs, and the other end of the interface unit 3 is connected to various wires.

The interface unit 3 is slidably connected to the box body 1; the interface unit 3 is in threaded fit with the adjustment unit 2; and the adjustment unit 2 is rotated to drive the interface unit 3 to move.

Scale lines 4 provided in a lengthwise direction of the adjustment unit 2 are further arranged on an inner wall of the box body 1. An antiskid structure 6 is arranged on an outer surface of the adjustment unit 2.

As an optional implementation solution of the present disclosure, by the arrangement of the scale lines 4, it is convenient for a user to precisely adjust a front end of the interface unit 3 according to the scale lines 4, making it easier to adapt to plug specifications of external intelligent terminals. By the arrangement of the antiskid structure 6, slippage during adjustment performed by a user is avoided; and the operation experience of a user is better.

### Embodiment 13

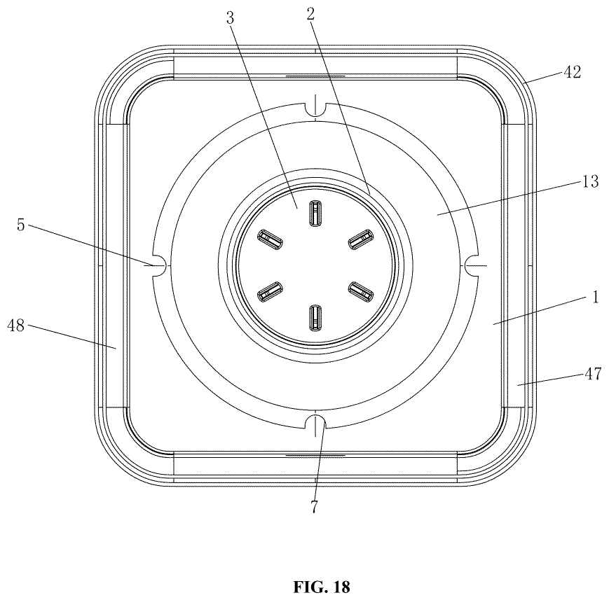

Referring to FIG. 18, the present disclosure provides the following technical solution: A compatible female socket includes:
a box body 1, wherein the box body 1 is provided with a protrusion 13 towards an opening of the box body 1, and the protrusion 13 is provided with a mounting opening 8;
an adjustment unit 2, wherein the adjustment unit 2 is rotatably connected to the mounting opening 8; and
an interface unit 3, wherein one end of the interface unit 3 facing the opening of the box body 1 is configured to connect various external plugs, and the other end of the interface unit 3 is connected to various wires.

The interface unit 3 is slidably connected to the box body 1; the interface unit 3 is in threaded fit with the adjustment unit 2; and the adjustment unit 2 is rotated to drive the interface unit 3 to move.

Alignment lines 5 are arranged on an inner wall of the box body 1 and the adjustment unit 2. An antiskid structure 6 is arranged on an outer surface of the adjustment unit 2.

As an optional implementation solution of the present disclosure, the alignment lines 5 are arranged on a bottom plane of the box body 1 or on a plane of the mounting opening 8, and the alignment lines 5 are further arranged on the antiskid structure 6. A moving distance of the interface unit 3 is measured according to each rotation of the adjustment unit 2. This design allows a user to clearly learn what angle the user should rotate the adjustment unit to make the interface unit 3 move to an appropriate position.

In this embodiment, the alignment lines 5 can be 360 annularly and uniformly distributed lines.

Further, four annularly and uniformly distributed recesses 7 can be arranged on the antiskid structure 6. Firstly, it is convenient for a user to have better grip points during adjustment; and secondly, every quarter of the rotation makes the moving distance of the interface unit 3 fixed. This also allows the user to precisely adjust the position of the interface unit 3.

### Embodiment 14

Referring to FIG. 3, the present disclosure provides the following technical solution: A compatible female socket includes a box body 1, an adjustment unit 2, and an interface unit 3. The adjustment unit 2 is rotatably connected to one side, facing an opening of the box body 1, in the box body 1.

The interface unit 3 includes a shell 19 and a decorative cover 20. A thread matched with the adjustment unit 2 is provided on a surface of the shell 19; the shell 19 is slidably connected into the adjustment unit 2; and the adjustment unit 2 is rotated to drive the interface unit 3 to move.

A limiting slot 24 which is arranged in a moving direction of the interface unit 3 is provided on an inner wall of the shell 19; and a plugging strip 25 matched with the limiting slot 24 is arranged on one side of the decorative cover 20 close to the shell 19, so that the decorative cover 20 can be plugged on an end surface of the shell 19 facing the opening of the box body 1. A first through hole 21 is provided inside the shell 19; and a conductive clamp 23 configured to be connected to various wires is fixedly connected into the first through hole 21. A second through hole 22 configured to connect various external plugs is provided on the decorative cover 20; and the second through hole 22 is aligned with the first through hole 21.

A safety door 26 is rotatably connected into the decorative cover 20 and between the decorative cover 20 and the shell 19; several penetration openings 27 aligned with the first through hole 21 are provided on the safety door 26; and an avoidance hole 28 for allowing the plugging strip 25 to pass through is further provided on the safety door 26. A baffle plate 29 is arranged at one end of the decorative cover 20 close to the safety door 26 and one side of the decorative cover located in the second through hole 22; when the safety door 26 is mounted at the decorative cover 20, the baffle plate 29 is located in the penetration openings 27; an avoidance slot 30 that is able to accommodate the baffle plate 29 is provided on one side wall surface of the safety door 26 located at the penetration openings 27; and the avoidance slot 30 is inclined or arc-shaped.

An arc-shaped accommodating slot 32 is provided on an end surface of the safety door 26 close to the shell 19; a reset spring 31 is arranged in the accommodating slot 32; and a convex block 33 capable of extending into the accommodating slot 32 is arranged on an end surface of the shell 19 close to the safety door 26. Two ends of the reset springs 31 are fixedly connected to an end portion of the accommodating slot 32 and the convex block 33, respectively. After being mounted, the reset spring 31 is kept in a stretched state at any time; and a direction of a counterforce of the reset spring 31 is a rotating direction for driving the safety door 26 to cover the first through hole 21. When no external plug is plugged into the interface unit 3 through the elasticity of the reset spring 31, the safety door 26 is kept in a state of blocking the first through hole 21 and the second through hole 22.

As an optional implementation solution of the present disclosure, this technical solution mainly aims at changes in connection between the reset spring 31 and the safety door 26, as well as the shell 19. Since the two ends of the reset spring 31 are fixedly connected to the safety door 26 and the shell 19, respectively, for example, due to hook connection, the reset spring 31 can alternatively use a tension spring, and the rotating door can be driven by tension. Although the tension mode may be slightly cumbersome for mounting compared to a compression mode, this allows the reset spring 31 to have more cross-sectional shapes for selection. Meanwhile, the accommodating slot 32 may further have more design selections for shapes, such as a tension spring with a rectangular cross section and an accommodating slot 32 with a rectangular cross section.

### Embodiment 15

Referring to FIG. 16, the present disclosure provides the following technical solution: An intelligent concealed box includes the above compatible female socket, and further includes an intelligent male socket 49. The intelligent male socket 49 includes:
a male plug 50, wherein the male plug 50 is plugged on the interface unit 3 to achieve electrification; and
a panel 51, wherein the panel 51 includes but is not limited to a button switch, a display, a touch screen, an intelligent switch, and other terminals.

The working principle and use process of the present disclosure are as follows: During pouring, the pre-buried box 42 is fixed on a load-bearing wall or a rough wall for pouring. After pouring, the detachable baffle plate 29 is knocked out to expose the threading openings 43, so that external circuits are pulled in via the threading openings 43. The conductive clamp 23 is plugged into the wiring frame 35, and the wiring frame 35 and the conductive clamp 23 are overall plugged into the first through hole 21. External wires pass through the end cover 36 via the third through holes 37 and are placed in the conductive clamp 23, and the screw 11 is screwed into the mounting hole 40 and the positioning hole 41, so that the external wires and the conductive clamp 23 are firmly fixed together to complete electric connection. The reset spring 31 is placed in the accommodating slot 32. The convex block 33 on the shell 19 resists against the other end of the reset spring 31. The plugging strip 25 passes through a middle hole of the safety door 26 and is plugged into the limiting slot 24 to complete the assembling of the whole interface unit 3. The limiting bracket 15 is mounted at a rear end of the protrusion 13. The box body 1 slides into the pre-buried box 42. Furthermore, the limiting structure 9 slides in the sliding chute 10. The interface unit 3 passes through the mounting opening 8, and a front end of the decorative cover 20 is exposed out of the mounting opening 8. The adjustment unit 2 is mounted on the interface unit 3, and completes threaded fit. The adjustment unit 2 is then pushed into the mounting opening 8 to complete clamping between the adjustment unit 2 and the protrusion 13, thus completing the mounting of the whole socket.

During use, the scale lines 4 are used as reference. Since the interface unit 3 is in sliding connection to and threaded fit with the box body 1, the adjustment unit 2 can be rotated to drive the interface unit 3 to move. The interface unit 3 is adjusted to the proper position where a plug of an intelligent terminal can be plugged.

The socket is a high-adaptability socket having a wide range of application scenes and further has the advantages of no wiring and ease of mounting. It is convenient for constructing delivered houses with lower decoration costs. In the future market of the socket industry, the present disclosure more easily meets different home decoration style designs, is convenient for adjusting a style, and can be well received by users. Therefore, the socket is easy for marketing and has a good market value.

The foregoing descriptions are merely preferred specific implementations of the present disclosure, but are not intended to limit the protection scope of the present disclosure. Equivalent replacements or changes made by any person skilled in the art within the technical scope disclosed in the present disclosure according to the technical solutions and invention concepts of the present disclosure shall all fall within the protection scope of the present disclosure.

What is claimed is:

1. A compatible female socket, comprising:
a box body;
an adjustment unit, wherein the adjustment unit is rotatably connected to one side, facing an opening of the box body, in the box body; and
an interface unit, wherein one end of the interface unit facing the opening of the box body is configured to connect various external plugs, and the other end of the interface unit is connected to various wires;
the interface unit is slidably connected to the box body; the interface unit is in threaded fit with the adjustment unit; and the adjustment unit is rotated to drive the interface unit to move.

2. The compatible female socket according to claim 1, wherein a thread on the interface unit is arranged at one end, close to the opening of the box body, of an outer surface of the interface unit; and the thread is stopped in front of an edge of an end portion of the interface unit, so that the adjustment unit is unable to be screwed out of the interface unit.

3. The compatible female socket according to claim 2, wherein the adjustment unit is made of a plastic part.

4. The compatible female socket according to claim 1, wherein scale lines provided in a lengthwise direction of the adjustment unit are further arranged on an inner wall of the box body.

5. The compatible female socket according to claim 1, wherein alignment lines are arranged on an inner wall of the box body and the adjustment unit.

6. The compatible female socket according to claim 1, wherein an antiskid structure is arranged on an outer surface of the adjustment unit.

7. The compatible female socket according to claim 6, wherein the antiskid structure comprises four ringlike recesses which are uniformly distributed.

8. The compatible female socket according to claim 1, wherein a mounting opening is provided in a bottom of the box body; and the adjustment unit is rotatably connected to the mounting opening.

9. The compatible female socket according to claim 8, wherein the box body is further provided with a limiting structure; the limiting structure is arranged in a manner of being parallel to a moving direction of the interface unit; a sliding chute is provided on an outer surface of the interface unit; and the limiting structure is slidably connected into the sliding chute.

10. The compatible female socket according to claim 9, wherein at least one end of the sliding chute does not penetrate through a thread on a surface of the entire interface unit.

11. The compatible female socket according to claim 8, wherein the adjustment unit is rotatably connected to an inner side of a rim of the mounting opening.

12. The compatible female socket according to claim 8, wherein a radial section of the mounting opening is U-shaped; and the adjustment unit is rotatably connected to an outer side of a rim of the mounting opening.

13. The compatible female socket according to claim 8, wherein the adjustment unit is rotatably connected to the mounting opening through a bearing.

14. The compatible female socket according to claim 8, wherein a clamping portion is arranged on an end surface of one end, opposite to the opening of the box body, of the adjustment unit; the clamping portion is matched with a rim of the mounting opening; and a radial section of the clamping portion is L-shaped.

15. The compatible female socket according to claim 9, further comprising a limiting bracket, wherein the limiting bracket is arranged on one side, away from the opening of the box body, of a bottom of the box body; the limiting structure is arranged on a center hole wall of the limiting bracket; the bottom of the box body has a protrusion towards the opening of the box body; and the mounting opening is arranged at the protrusion.

16. The compatible female socket according to claim 15, wherein several wiring terminals are arranged on one side of the protrusion away from an orientation of the opening of the box body; and the limiting bracket is fixedly mounted on the wiring terminals.

17. The compatible female socket according to claim 15 wherein the protrusion is tubular; the mounting opening is arranged on an end surface of the protrusion facing the opening of the box body; and a diameter of the mounting opening is less than an inner diameter of the protrusion.

18. The compatible female socket according to claim 15, wherein the protrusion is horn-like; and the limiting bracket is fixedly connected to a surface of one side, away from the adjustment unit, of the protrusion.

19. The compatible female socket according to claim 15, wherein the limiting bracket and the protrusion are adhered and fixed with each other.

20. The compatible female socket according to claim 15, wherein several screw holes are provided on a surface of the protrusion; and screws are screwed into the screw holes to fix the limiting bracket.

21. The compatible female socket according to claim 15, wherein several buckle slots are provided on a surface of the protrusion opposite to the opening of the box body; and buckles matched with the buckle slots are arranged on a surface of one side, close to the protrusion, of the limiting bracket.

22. The compatible female socket according to claim 2, wherein the interface unit comprises:
a shell, wherein a thread is provided on a surface of the shell; the shell is slidably connected into the adjustment unit; a first through hole is provided inside the shell; and
a decorative cover, wherein the decorative cover is plugged onto an end surface of the shell facing the opening of the box body; a second through hole is provided on the decorative cover; the second through hole is aligned with the first through hole; and
a conductive clamp is fixedly connected into the first through hole.

23. The compatible female socket according to claim 22, wherein a limiting slot which is arranged in the moving direction of the interface unit is provided in the shell; and the decorative cover is provided with a plugging strip matched with the limiting slot.

24. The compatible female socket according to claim 23, wherein the limiting slot is provided on an inner wall of the shell.

25. The compatible female socket according to claim 22, further comprising a safety door, wherein the safety door is rotatably connected into the decorative cover and is located between the decorative cover and the shell; several penetration openings aligned with the first through hole are provided on the safety door; and an avoidance hole for allowing the plugging strip to pass through is further provided on the safety door.

26. The compatible female socket according to claim 25, wherein a baffle plate is arranged at one end of the decorative cover close to the safety door and one side of the decorative cover located in the second through hole; when the safety door is mounted at the decorative cover, the baffle plate is located in the penetration openings; an avoidance slot that is able to accommodate the baffle plate is provided on one side wall surface of the safety door located at the penetration openings; and the avoidance slot is inclined or arc-shaped.

27. The compatible female socket according to claim 26, wherein a reset spring is further arranged at the safety door; one end of the reset spring is connected to the safety door; the other end of the reset spring is connected to the shell or the decorative cover; and
when no external plug is plugged into the interface unit through the elasticity of the reset spring, the safety door is kept in a state of blocking the first through hole and the second through hole.

28. The compatible female socket according to claim 27, wherein an arc-shaped accommodating slot is provided on an end surface of the safety door close to the shell; the reset spring is mounted in the accommodating slot; and a convex block capable of extending into the accommodating slot is arranged on an end surface of the shell close to the safety door.

29. The compatible female socket according to claim 28, wherein two ends of the reset spring respectively resist against an end portion of the accommodating slot and the convex block; after being mounted, the reset spring is kept in a compressed state at any time; and a direction of a counterforce of the reset spring is a rotating direction for driving the safety door to cover the first through hole.

30. The compatible female socket according to claim 28, wherein two ends of the reset spring are respectively fixedly connected to an end portion of the accommodating slot and the convex block; after being mounted, the reset spring is kept in a stretched state at any time;
and a direction of a counterforce of the reset spring is a rotating direction for driving the safety door to cover the first through hole.

31. The compatible female socket according to claim 22, further comprising a wiring unit, wherein the wiring unit is fixedly connected to the conductive clamp; the wiring unit comprises:
a wiring frame, wherein the wiring frame is plugged into the first through hole; the conductive clamp is fixedly connected into the wiring frame; and
an end cover, wherein the end cover is fixedly connected to one end of the shell away from the decorative cover; several third through holes aligned with the first through hole are provided on the end cover; and
the third through holes are configured for connection of wires.

32. The compatible female socket according to claim 31, wherein a hook is arranged at an outer edge of the end cover; and a hook hole is provided on an outer surface of one side, close to the end cover, of the shell.

33. The compatible female socket according to claim 31, wherein a mounting hole capable of penetrating through the first through hole is provided on an outer surface of one side, close to the end cover, of the shell; a positioning hole is provided on one side of the wiring frame close to the mounting hole; a portion of one side, close to the end cover, of the conductive clamp is U-shaped; and a screw is screwed into the mounting hole to achieve connection of circuits.

34. The compatible female socket according to claim 22, further comprising a pre-buried box, wherein the pre-buried box is pre-buried on a building; and the box body is detachably connected into an embedded part,

35. The compatible female socket according to claim 34, wherein several threading openings are provided on a surface of the pre-buried box; and detachable stop sheets are arranged in the threading openings.

36. The compatible female socket according to claim 34, wherein several limiting convex strips are arranged on an inner wall of the pre-buried box; surfaces of the limiting convex strips facing an opening of the pre-buried box are inclined; and profiled holes matched with the limiting convex strips are provided on the box body.

37. The compatible female socket according to claim 34, wherein bent edges are arranged at a rim of the pre-buried box and a rim of the box body.

38. The compatible female socket according to claim 37, wherein magnetic suction sheets are arranged at the bent edges.

39. An intelligent concealed box, comprising the compatible female socket according to claim 34, and further comprising an intelligent male socket, wherein the intelligent male socket comprises:
a male plug, wherein the male plug is plugged on the interface unit to achieve electrification; and
a panel, wherein the panel comprises but is not limited to a button switch, a display, a touch screen, an intelligent switch, and other terminals.
